(19) United States
(12) Patent Application Publication
(10) Pub. No.: US 2013/0161055 A1
(43) Pub. Date: Jun. 27, 2013

(54) RETRACTABLE CABLE

(71) Applicant: 3M Innovative Properties Company, St. Paul, MN (US)

(72) Inventors: Joseph D. Rule, Cottage Grove, MN (US); Rebecca A. Johnson, St. Paul, MN (US); Sharilyn K. Loushin, Eagan, MN (US)

(73) Assignee: 3M INNOVATIVE PROPERTIES COMPANY, ST. PAUL, MN (US)

(21) Appl. No.: 13/721,299

(22) Filed: Dec. 20, 2012

Related U.S. Application Data
(60) Provisional application No. 61/578,616, filed on Dec. 21, 2011.

(51) Int. Cl. H01B 7/04

(52) U.S. Cl. CPC H01B 7/04
USPC 174/69

(57) ABSTRACT

There is provided a retractable cable comprising: a first member and a conductive second member configured together and both of which are capable of stretching, wherein the first member is capable of stretching to at least 1.25 times its relaxed length and, only upon heating, retracting to substantially its relaxed length without substantial damage to the cable; and further wherein a refractive force of the first member retracts both the first and second members.

### CROSS REFERENCE TO RELATED APPLICATION

This application claims the benefit of U.S. Provisional Patent Application No. 61/578,616, filed Dec. 21, 2011, the disclosure of which is incorporated by reference herein in its entirety.

### FIELD

This disclosure relates to a retractable cable.

### BACKGROUND

Stretchable cables are useful in a variety of applications, such as for example electrically conductive or resistive cables. Examples of applications in which such cables are used include implantable medical devices, flexible displays, wearable electronic clothing, smart skin, and sensors. In such applications it is desirable for such cables to have a high degree of flexibility and compliance in order to accommodate a multitude of possible movements. It is also desirable in at least some applications to provide a longer length for such cables at certain times, such as during manufacturing, installation, use and the like, while allowing for retraction to a shorter length at other times, such as during use, repair, and the like.

Conductive rubbers, such as silicone rubber filled with silver or carbon particles, have been used to create stretchable cables that are mechanically elastic and electrically conductive. However, these types of cables can have a very high electrical resistivity that is affected by stretching the cable.

Another kind of stretchable cable has been created by arranging one or more layers of conductive material in a helical shape around an insulating support, wherein the conductive material is, for example, titanium or platinum, and the insulating support is a suitable biocompatible material such as silicone rubber. However, the traditional method of arranging layers of conductive material on an insulating support is performed by simply depositing a continuous form of conductive material along the length of the support. This results in fractures occurring in the layers of conductive material when the cable is stretched beyond 10-20% of its original length. Consequently, these types of cable are prone to loss of conductivity.

Implantable conducting cables, or leads, are suitable for electrical stimulation applications, such as cochlear implants. See, e.g. US2006/0206185, WO83/04182 and US2004/0055776. These types of conducting leads generally include a plurality of metallic wires extending through an insulating body in helically wound arrangement. Each of the metallic wires is typically made up of a plurality of separate electrical conductors. However, these types of conducting leads do not provide a good degree of flexibility due to the presence of the plurality of separate electrical conductors.

Other types of electrically conductive cables attempt to address issues of flexibility, compliance and conductivity by using elastomeric materials. However, the previously used elastomeric materials cannot maintain their elongated length at ambient temperature without an applied force.

There is a need for flexible cable that can be stretched and maintain its elongated length and, then, at a later time can be retracted to substantially its original length.

### SUMMARY

The present disclosure provides a flexible cable that can be stretched and maintain its elongated length and, then, at a later time can be retracted to substantially its original length.

In one aspect the present disclosure provides a retractable cable comprising: a first member and a conductive second member configured together and both of which are capable of stretching, wherein the first member is capable of stretching to at least 1.25 times its relaxed length and, only upon heating, retracting to substantially its relaxed length without substantial damage to the cable; and further wherein a retractive force of the first member retracts both the first and second members. In some embodiments, the first member is positioned within the second member. In some embodiments, the second member is positioned within the first member. In some embodiments, the first and second members are radially spaced apart concentric members. The presently disclosed retractable cable can be an electrically conductive cable or an electrically resistive cable.

In some embodiments, the first member retains a length of at least 1.1 times its relaxed length after being stretched to at least 1.25 times its relaxed length. In some embodiments, the first member retains a length of at least 1.25 its relaxed length after being stretched to at least 1.5 times its relaxed length.

In some embodiments, the first member retracts to at most 1.1 times its relaxed length after heating. In some embodiments, the first member retracts to at most 1.05 times its relaxed length after heating.

In some embodiments, a retractive force of the second member provides a second retractive force on the cable. In some embodiments, a retractive force of the second member does not provide additional retractive force on the cable. In some embodiments, the presently disclosed retractable cable further comprises a third member that is a dead stop selected to prevent over stretching of the first member, the second member, or both the first and second members.

In some embodiments, the first member comprises multiple strands, which can be selected from similar materials or dissimilar materials. In some embodiments, the second member comprises multiple strands, which can be selected from similar materials or dissimilar materials.

In some embodiments, the second member is selected from materials comprising conductive metals, conductive polymers, conductive liquids, and wave guide polymers.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 is a cross sectional side view of an embodiment of the presently disclosed retractable cable.

FIG. 2 is a side view of an embodiment of the presently disclosed retractable cable.

FIG. 3 is a side view of an embodiment of the presently disclosed retractable cable.

FIG. 4 is a side view of an embodiment of the presently disclosed retractable cable.

FIG. 5 is a side perspective view of an embodiment of the presently disclosed retractable cable.

FIG. 6 is a side perspective view of an embodiment of the presently disclosed retractable cable.

### DETAILED DESCRIPTION

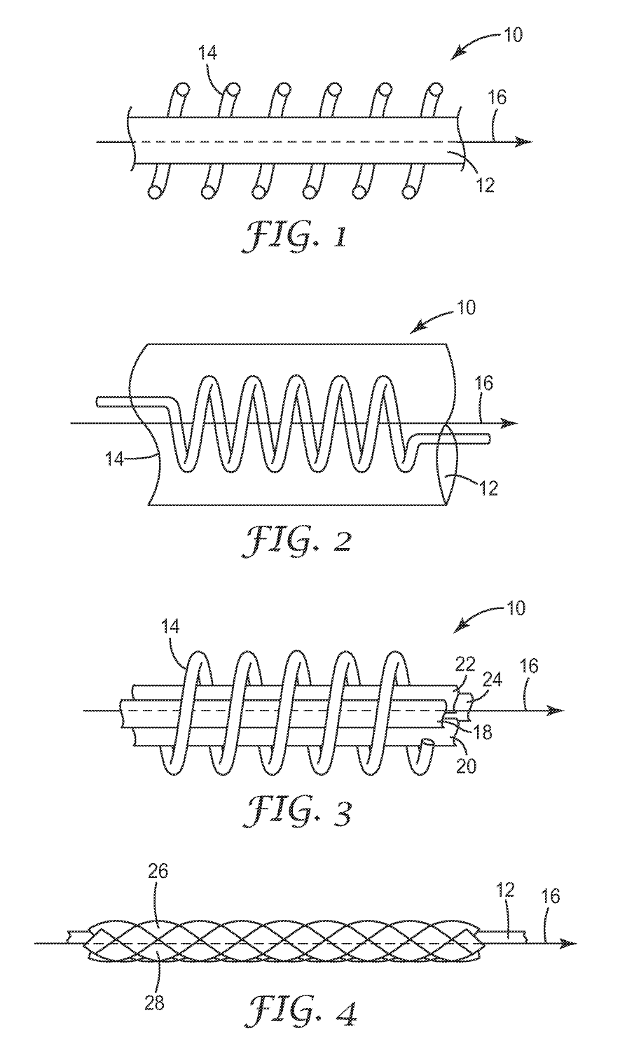

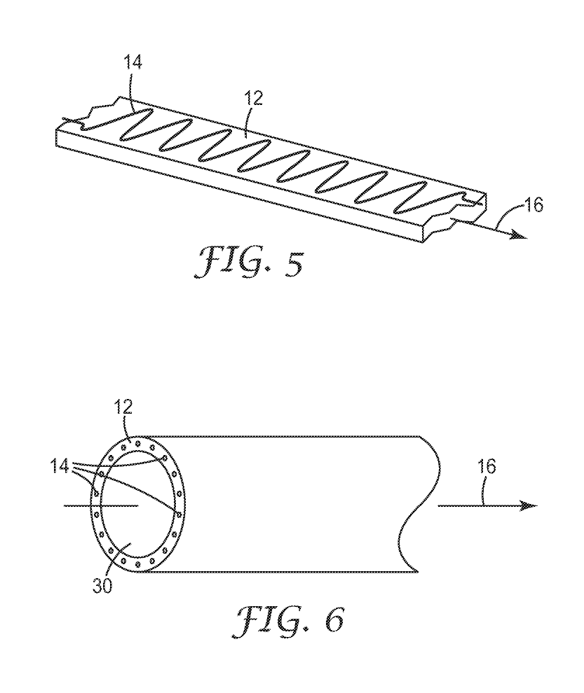

The present disclosure provides a retractable cable having a first member and a conductive second member configured together and both of which are capable of stretching. The presently disclosed retractable cable is electrically conductive in some embodiments. In some embodiments, the presently disclosed retractable cable is electrically resistive. The first and second members can be configured together in various ways. For example, referring now to FIG. 1, in some embodiments, the retractable cable 10 includes the first member 12 positioned within the second member 14. The first member 12 and second member 14 stretch and retract in the same direction and along the same plane, such as for example, shown as direction 16 in FIG. 1. In some embodiments, the first 12 and second member 14 are radially spaced apart concentric members. For example, in the embodiment shown in FIG. 1, the first member 12 and second member 14 are radially spaced apart concentric members. In some embodiments, the first member 12 and second member 14 have different shapes or configurations. For example, FIG. 5 shows an example of embodiments in which the first member 12 has a rectilinear shape. In FIG. 5, the second member 14 is disposed within the first member 12, however, it could also be configured such that the second member 14 contains the first member 12. While the second member 14 shown in FIG. 1 is wound around the first member 12 and that shown in FIG. 5 has a repeating “S” shaped configuration, one of skill in the art can appreciate that the second member 14 can be figured in any manner of ways, such as, for example, “Z” shaped configurations, helical configurations, and the like.

Referring now to FIG. 2, there is shown an example of embodiments of the presently disclosed retractable cable 10 in which the second member 14 is positioned within the first member 12. The first member 12 and second member 14 stretch and retract in the same direction and along the same plane, such as for example, shown as direction 16 in FIG. 2. In this embodiment, the first member 12 and second member 14 may be radially spaced apart concentric members. In some embodiments, the first member 12 and second member 14 have different shapes or configurations. For example, FIG. 5 shows an example of embodiments in which the first member 12 has a rectilinear shape. The second member 14 is disposed within the first member 12 and can be configured in any manner. For example, the second member 14 shown in FIG. 2 is wound within the first member 12 and that shown in FIG. 5 has a repeating “S” shaped configuration. One of skill in the art can appreciate that the second member 14 can also be configured in any manner of ways, such as, for example, “Z” shaped configurations, helical configurations, and the like.

Referring now to FIG. 3, there is shown an example of embodiments of the presently disclosed retractable cable 10 in which there are a plurality of first members 18, 20, 22 and 24 positioned within at least one second member 14. The plurality of first members 18, 20, 22 and 24 and the second member 14 stretch and retract in the same direction and along the same plane, such as for example, shown as direction 16 in FIG. 3. In some embodiments, the plurality of first members 18, 20, 22 and 24 are multiple strands of material that collectively comprise first member 12. In some embodiments, the plurality of first members 18, 20, 22 and 24, i.e. multiple strands, all comprise the same or similar materials. In some embodiments, the plurality of first members 18, 20, 22 and 24, i.e. multiple strands, all comprise dissimilar or substantially similar materials. The second member 14 shown in FIG. 3 is wound around the plurality of first members 18, 20, 22 and 24. However, one of skill in the art can appreciate that the second member 14 can also be configured in any manner of ways, such as, for example, “Z” shaped configurations, helical configurations, and the like.

Referring now to FIG. 4, there is shown an example of embodiments of the presently disclosed retractable cable 10 in which the first member 12 is contained within a plurality of second members 26 and 28. The first member 12 and plurality of second members 26 and 28 stretch and retract in the same direction and along the same plane, such as for example, shown as direction 16 in FIG. 4. In some embodiments, the plurality of second members 26 and 28 are multiple strands of material that collectively comprise second member 14. In some embodiments, the plurality of second members 26 and 28, i.e. multiple strands, all comprise the same or similar materials. In some embodiments, the plurality of second members 26 and 28, i.e. multiple strands, all comprise dissimilar or substantially similar materials. The plurality of second members 26 and 26 shown in FIG. 4 is configured around the first member 12 in a woven configuration. However, one of skill in the art can appreciate that the plurality of second members 26 and 28 can also be configured in any manner of ways. In some embodiments, the individual strands in the plurality of second members 26 and 28 are insulated from one another.

Referring now to FIG. 6, there is shown an example of embodiments of the presently disclosed retractable cable 10 in which a plurality of second members 14 are disposed within the first member 12. There is a cavity 30 enclosed within the combination of the first member 12 and the plurality of second members 14. In some embodiments, the cavity 30 is filled with at least one additional material, such as, for example, a conductive liquid, a conductive polymer, a wave guide polymer, a metal, and the like. One of skill in the art can appreciate that the first member 12 and second member 14 can be figured together in any manner of ways to create the cavity 30 therewithin. For example, any of the aforementioned embodiments could be modified to include at least one additional material within any cavities therewithin.

The following descriptions of the first member and second member are useful for all of the aforementioned embodiments of the presently disclosed retractable cable. The first member is preferably composed of a material that allows it to substantially stretch and hold a stretched configuration until or unless some other action is performed to retract it. In some embodiments, the first member is capable of stretching to at least 1.25 times its relaxed length and, only upon heating, retracting to substantially its relaxed length without substantial damage to the cable. For example, in order to effect refraction, the cable could be heated above ambient temperature in some embodiments, to, at, or above 50° C. in some embodiments; to, at, or above 115° C. in some embodiments; and even to, at, or above 130° C. in some embodiments.

Exemplary materials useful in the first member in the presently disclosed retractable cable include materials that are capable both of cold-draw and shape memory. For example, in some embodiments, useful materials are those having a glass transition or melt transition higher than room temperature. In some embodiments, useful materials are those that are capable of significant strain, such as greater than or equal to about 25%, at room temperature. In some embodiments, useful materials are those that have a measurable crosslink density. In some embodiments a combination of two or all three of the aforementioned characteristics is desirable for the material selected for use in the first member. Examples of such materials include polyolefins (such as crosslinked polyethylene), polyurethanes, and metathesis polymers (including polycyclooctene and polydicyclopentadiene polymers and copolymers). Heat shrink tubing material commercially available from 3M Company, St. Paul, Minn., also provides similar properties. In some embodiments, polyvinyl chloride (PVC), polyamides (PA), polyesters, polycarbonates, and acrylonitrile-butadiene-styrene copolymers (ABS) may also be used, particularly if they are subjected to crosslinking.

In some embodiments, the second member 14 can be conductive. The term “conductive” as used herein means having the property of conducting something, such as electricity, heat, light, and the like. In some embodiments, the second member 14 comprises at least one conductive material, such as for example, conductive metals, conductive polymers, waveguide polymers, and/or glass.

The design of the presently disclosed retractable cable needs to balance the properties of the first member with the properties of the second member. As the retractable cable is extended, the second member elongates by increasing the distance between the coils, “S” shapes, “Z” shapes, or whatever configuration is used. With some common conductive materials, such as copper and aluminum, this deformation tends to be mostly inelastic, meaning that the second member would not spontaneously return to substantially its original length or dimensions if unconstrained. Therefore, a force needs to be applied to the second member to retract it to substantially its original length or dimensions. For the first member to cause the retractable cable to return to substantially its original length, the elastic force generated by the first member must at least overcome any resistance to deformation caused by the second member. In some embodiments, this can be achieved by balancing a relatively high first member rubber modulus and a relatively large first member cross-section with a relatively small second member cross-section. In some embodiments, then, the retractable cable has a retractive force of the first member that retracts both the first and second members. In some embodiments, a retractive force of the second member does not provide a second refractive force on the cable. In some embodiments, a retractive force of the second member provides a second retractive force on the cable.

In some embodiments, the presently disclosed retractable cable includes a third member that is a dead stop selected to prevent over stretching of the first member, the second member, or both the first and second members.

Various methods can be used to make the presently disclosed retractable cables. In some embodiments, the presently disclosed retractable cable is made by extending at least one first member, then configuring at least one second member with the extended first member(s). Configuring the at least one second member with the at least one first member can be done in a variety of ways, such as wrapping at least one second member around at least one first member, braiding a plurality of second members around the first member, braiding at least one of the second members with at least one of the elongated first members, and the like. The final step is to relax the resulting retractable cable at elevated temperature. The term “relaxed length” as used herein means the length of the cable after exposure to elevated temperature and before any elongation is applied to the cable.

In some embodiments, at least one second member is configured around at least one first member while the first member(s) is in its relaxed position. A substantial amount of slack in the second member(s) should be left when using this method. This can be achieved in a variety of ways, such as for example, by wrapping at least one second member loosely around at least one first member with relatively closely-spaced coils. In this manner, the at least one second member will be able to elongate when necessary. The term “relaxed length” as used herein means the length of the cable before any elongation is applied to the cable.

Objects and advantages of this invention are further illustrated by the following examples, but the particular materials and amounts thereof recited in these examples, as well as other conditions and details, should not be construed to unduly limit this invention. In the examples, all temperatures are in degrees Centigrade and all parts and percentages are by weight unless indicated otherwise.

Various embodiments and combinations of embodiments of the presently disclosed retractable cable include the following:

1. A retractable cable comprising:
a first member and a conductive second member configured together and both of which are capable of stretching,
wherein the first member is capable of stretching to at least 1.25 times its relaxed length and, only upon heating, retracting to substantially its relaxed length without substantial damage to the cable; and
further wherein a retractive force of the first member retracts both the first and second members.
   2. The cable of claim 1 wherein the first member is positioned within the second member.
   3. The cable of claim 1 wherein the second member is positioned within the first member.
   4. The cable of claim 1 wherein the first and second members are radially spaced apart concentric members.
   5. The cable of any of the preceding claims wherein the retractable cable is an electrically conductive cable.
   6. The cable of any of claims 1 to 4 wherein the retractable cable is an electrically resistive cable.
   7. The cable of any of the preceding claims wherein a retractive force of the second member provides a second retractive force on the cable.
   8. The cable of any of claims 1 to 6 wherein a retractive force of the second member does not provide additional retractive force on the cable.
   9. The cable of any of the preceding claims further comprising a third member that is a dead stop selected to prevent over stretching of the first member, the second member, or both the first and second members.
   10. The cable of any of the preceding claims wherein the first member comprises multiple strands.
   11. The cable of claim 10 wherein the multiple strands are selected from similar materials.
   12. The cable of claim 10 wherein the multiple strands are selected from dissimilar materials.
   13. The cable of any of the preceding claims wherein the second member comprises multiple strands.
   14. The cable of claim 13 wherein the multiple strands are selected from similar materials.
   15. The cable of claim 13 wherein the multiple strands are selected from dissimilar materials.
   16. The cable of any of claims 13 to 15 wherein the individual strands are insulated from one another.
   17. The cable of any of the preceding claims wherein the second member is selected from materials comprising conductive metals, conductive polymers, conductive liquids, and wave guide polymers.

Various modifications and alterations of this invention will become apparent to those skilled in the art without departing from the scope and spirit of this invention.

### EXAMPLES

### Example 1

Crosslinked polyethylene shrink film (0.05 mm thick, available under the trade designation “CorTuff 200” from Sealed Air Corporation, Elmwood Park, N.J.) was slit into strips 1.6 mm wide by 350 mm long using a tool with parallel razor blades. These strips were put into a 140° C. oven for 60 seconds, during which time they shrank in length and width and increased in thickness to form strips 60 mm long with a 0.5 mm×0.7 mm cross-section. Four of these resulting strands were aligned, and a 30 mm long section of this bundle was marked with ink. The bundle was stretched by hand at room temperature until the section had been extended to 90 mm long. When the bundle was released, the length decreased slightly, and the marked section was 75 mm in length. That 75 mm section was wrapped with a 0.11 mm diameter solid aluminum wire with 14 wraps over a 30 mm section. This assembly was then placed in a 130° C. oven for 30 seconds, and the 75 mm long section decreased to 40 mm in length. After cooling, it was stretched by hand to 70 mm in length, and when released, the section recovered slightly to 60 mm in length. The sample was returned to the 130° C. oven for 30 seconds, and the marked section decreased to 35 mm in length. After cooling, the sample was subjected to two additional cycles of stretching and heating with the same resulting length changes.

### Example 2

Heat shrink tubing (6.4 mm diameter available from 3M Company, St. Paul, Minn.) was slit down its length to form a strip. This strip was further slit to form individual strands 1.6 mm wide by 150 mm long. When these strands were heated in a 120° C. oven, and they relaxed to form strands with a cross-section of 0.7 mm×0.6 mm×200 mm. Five of these strands and a piece of solid aluminum wire (0.11 mm diameter) were aligned to form a bundle. An overhand knot was tied in one end of the bundle to fix that end. The heat shrink strands were then elongated by hand to approximately 300 mm, and the wire was wrapped around the stretched strands 42 times. An additional overhand knot was tied in the other end of the bundle to fix the second end with approximately 110 mm between the knots. The resulting cable was heated in a 115° C. oven for five minutes, during which time, the distance between the knots relaxed to 56 mm. Each knot was then held in pneumatic grips on an Instron tensile tester in a controlled environment of 23° C. The cable was elongated at a rate of 200% elongation per minute to 100% elongation, and it was then unloaded at the same rate. Upon unloading, the cable reached zero load at 54% elongation. After removing the sample from the grips, the distance between knots was 77 mm. The sample was heated in a 115° C. oven for five minutes, and its length decreased to 56 mm.

### Example 3

A piece of 0.11 mm diameter aluminum wire was wound 40 times around a wire mandrel with a diameter of 1.6 mm, and the resulting aluminum coil was then removed from the wire mandrel and adjusted to be 56 mm in length. The coil was then placed inside a 56 mm length of heat shrink tubing (6.4 mm diameter). This assembly was placed in a 115° C. oven for five minutes, during which time the heat shrink tubing contracted to an inside diameter of approximately 1.8 mm while maintaining the 56 mm length. The resulting cable was gripped in pneumatic grips on an Instron tester with a grip separation of 47 mm. The cable was elongated at a rate of 200% elongation per minute to 100% elongation, and it was then unloaded at the same rate. Upon unloading, the cable reached zero load at 53% elongation. After removing the sample from the grips, the total sample length was 72 mm. The sample was heated in a 115° C. oven for five minutes, and its length decreased to 58 mm.

### Example 4

A shape memory polyurethane film was prepared by mixing 10 grams of an HDI trimer, commercially available under the trade designation “Desmodur N3300A” from Bayer Corp, Pittsburgh, Pa., with 14.05 grams of a polyester diol, commercially available under the trade designation “K-flex 188” from King Industries, Norwalk, Conn., along with 1 syringe drop of a dibutyl tin dilaurate commercially available under the trade designation “Dabco T12 catalyst” from Air Products and Chemicals, Inc., Allentown, Pa. This composition was mixed using a mixer, commercially available under the trade designation “Speedmixer model DAC 150FV” from Flaktec Ind., Landrum S.C. The composition was mixed for 30 seconds at 3450 rpm. The composition was then coated between two silicone release liners, commercially available under the trade designation “UV10 PET” from CP Films, Fieldale, Va., using a notchbar coating apparatus with the coating gap set at 5 mils. The film composite was then allowed to cure under room temperature conditions after which the liners were removed resulting in a shape memory polyurethane film. This film was cut into strands 1.1 mm wide×0.1 mm thick. Four polyurethane strands and a piece of solid copper wire (0.15 mm diameter) were aligned to form a bundle. An overhand knot was tied in one end of the bundle. The polyurethane strands were aligned with a wire mandrel (0.9 mm diameter), and the copper wire was wrapped around the polyurethane and mandrel 38 times. The mandrel was then removed, and an additional overhand knot was tied in second end of the bundle to fix that end. The distance between the knots of the resulting cable was 58 mm. Each knot was then held in pneumatic grips on an Instron tensile tester in a controlled environment of 23° C. The cable was elongated at a rate of 200% elongation per minute to 85% elongation, and it was then unloaded at the same rate. Upon unloading, the cable reached zero load at 73% elongation. After removing the sample from the grips, the distance between knots was 85 mm. The sample was heated in a 50° C. oven for five minutes, and its length decreased to 59 mm.

### Comparative Example 1

Two natural rubber strands (1.7 mm wide×0.7 mm thick×140 mm long) and a piece of solid aluminum wire (0.11 mm diameter) were aligned to form a bundle. An overhand knot was tied in one end of the bundle. The rubber strands were then elongated by hand to approximately 250 mm, and the wire was wrapped around the stretched strands 38 times. An additional overhand knot was tied in the bundle approximately 150 mm from the first knot to fix the second end. After relaxing, the length between knots was 75 mm. Each knot was then held in pneumatic grips on an Instron tensile tester in a controlled environment of 23° C. The cable was elongated at a rate of 200% elongation per minute to 100% elongation, and it was then unloaded at the same rate. Upon unloading, the cable reached zero load only when returned to 0% elongation. After removing the sample from the grips, the distance between knots was 75 mm.

### Comparative Example 2

Twenty spandex strands, commercially available from Radici Spandex Corp. Gastonia, N.C. (type S-17, 210 denier), and a piece of solid aluminum wire (0.11 mm diameter) were aligned to form a bundle. An overhand knot was tied in one end of the bundle. The spandex strands were then elongated by hand from approximately 250 mm to approximately 500 mm, and the wire was wrapped around the stretched strands 60 times. An additional overhand knot was tied in the bundle approximately 320 mm from the first knot to fix the second end. After relaxing, the length between knots was 158 mm. Each knot was then held in pneumatic grips on an Instron tensile tester in a controlled environment of 23° C. The cable was elongated at a rate of 200% elongation per minute to 75% elongation, and it was then unloaded at the same rate. Upon unloading, the cable reached zero load at 10% elongation. After removing the sample from the grips, the distance between knots was 158 mm. ×

### Comparative Example 3

One strand of a thermoplastic vulcanizate commercially available under the trade designation “Santoprene” from ExxonMobil Chemical Copmany, Houston, Tex. (type 101-64, 1.8 mm wide×1.2 mm thick), and a piece of solid aluminum wire (0.11 mm diameter) were aligned to form a bundle. An overhand knot was tied in one end of the bundle. The Sanotprene strand was elongated by hand from approximately 140 mm to approximately 210 mm, and the wire was wrapped around the stretched strands 29 times. An additional overhand knot was tied in the bundle approximately 140 mm from the first knot to fix the second end. After relaxing, the length between knots was 91 mm. Each knot was then held in pneumatic grips on an Instron tensile tester in a controlled environment of 23° C. The cable was elongated at a rate of 200% elongation per minute to 50% elongation, and it was then unloaded at the same rate. Upon unloading, the cable reached zero load at 11% elongation. After removing the sample from the grips, the distance between knots was 97 mm. The sample was heated in a 115° C. oven for five minutes, and its length decreased to 91 mm.

### Comparative Example 4

The center section of a piece of aluminum wire (0.11 mm diameter) was wrapped 40 times around a wire mandrel (1.6 mm diameter) and then removed from the mandrel to produce an aluminum coil having tag ends of straight wire extending from each end of the coil. The coiled section was adjusted to a length of 70 mm. The wire tag ends were held in pneumatic grips on an Instron tensile tester in a controlled environment of 23° C. with an initial grip separation of 70 mm. The coil was elongated at a rate of 200% elongation per minute to 100% elongation, and it was then unloaded at the same rate. Upon unloading, the coil reached zero load at 85% elongation. After removing the sample from the grips, the coil was 120 mm long.

TABLE 1

| | | | | Elong at | Fixed | Final |
|---|---|---|---|---|---|---|
| Example | Polymer | Conductor | Elong* | 0 Load** | Elong*** | Elong**** |
| Example 1 | Polyethylene | Al | 100% | — | 71% | 0% |
| Example 2 | Heat Shrink - | Al | 200% | 54% | 38% | 0% |
| | Strand | | | | | |
| Example 3 | Heat Shrink - | Al | 200% | 53% | 34% | 4% |
| | Tube | | | | | |
| Example 4 | Polyurethane | Cu | 85% | 73% | 47% | 2% |
| Comp. | Natural Rubber | Al | 100% | 0% | 0% | Not |
| Example 1 | | | | | | Measured |
| Comp. | Spandex | Al | 75% | 10% | 0% | Not |
| Example 2 | | | | | | Measured |
| Comp. | Santoprene | Al | 50% | 11% | 7% | 0% |
| Example 3 | | | | | | |
| Comp. | None | Al | 100% | 85% | 71% | Not |
| Example 4 | | | | | | Measured |

*Elongation: (maximum length of stretched sample/by initial length of sample) − 1
**Elongation at 0 Load: (length of sample when the overall retractive force drops to zero upon unloading/initial length of sample) − 1
***Fixed Elongation: (Length of sample after removal from the grips/Initial length of sample) − 1
****Final Elongation: (Length of sample after heating/initial length of sample) − 1

What is claimed is:

1. A retractable cable comprising:
a first member and a conductive second member configured together and both of which are capable of stretching,
wherein the first member is capable of stretching to at least 1.25 times its relaxed length and, only upon heating, retracting to substantially its relaxed length without substantial damage to the cable; and
further wherein a retractive force of the first member retracts both the first and second members.

2. The cable of claim 1 wherein the first member is positioned within the second member.

3. The cable of claim 1 wherein the second member is positioned within the first member.

4. The cable of claim 1 wherein the first and second members are radially spaced apart concentric members.

5. The cable of any of the preceding claims wherein the retractable cable is an electrically conductive cable.

6. The cable of any of claims 1 to 4 wherein the retractable cable is an electrically resistive cable.

7. The cable of any of the preceding claims wherein a retractive force of the second member provides a second retractive force on the cable.

8. The cable of any of claims 1 to 6 wherein a retractive force of the second member does not provide additional retractive force on the cable.

9. The cable of any of the preceding claims further comprising a third member that is a dead stop selected to prevent over stretching of the first member, the second member, or both the first and second members.

10. The cable of any of the preceding claims wherein the first member comprises multiple strands.

11. The cable of claim 10 wherein the multiple strands are selected from similar materials.

12. The cable of claim 10 wherein the multiple strands are selected from dissimilar materials.

13. The cable of any of the preceding claims wherein the second member comprises multiple strands.

14. The cable of claim 13 wherein the multiple strands are selected from similar materials.

15. The cable of claim 13 wherein the multiple strands are selected from dissimilar materials.

16. The cable of any of claims 13 to 15 wherein the individual strands are insulated from one another.

17. The cable of any of the preceding claims wherein the second member is selected from materials comprising conductive metals, conductive polymers, conductive liquids, and wave guide polymers.
